(19) United States
(12) Patent Application Publication
(10) Pub. No.: US 2024/0243597 A1
(43) Pub. Date: Jul. 18, 2024

(54) SELF POWERED BASE STATION FOR MODULAR HOUSE

(71) Applicant: A&C FUTURE, INC., Newport Beach, CA (US)

(72) Inventors: Shoue CHEN, Irvine, CA (US); Zhuangboyu Zhou, Santa Ana, CA (US); Xunmin Jiang, Irvine, CA (US); Sichen Li, Santa Ana, CA (US); Ju Gao, Newport Beach, CA (US); Jiuqi Wang, Santa Ana, CA (US); Han Qin, Newport Beach, CA (US); Jiayang Qin, Newport Beach, CA (US)

(21) Appl. No.: 18/153,952

(22) Filed: Jan. 12, 2023

(51) Int. Cl. H02J 7/00; F03D 3/00; F24D 17/00; H02J 7/14; H02J 7/35

(52) U.S. Cl. CPC H02J 7/0063; F03D 3/005; F24D 17/001; H02J 7/14; H02J 7/35; H04W 88/085

(57) ABSTRACT

A self-powered mobile base station unit, intended for modular houses and other dwellings, is connected via optical fiber or microwave backhaul to provide an improved arrangement of communication base station networks to cater for the fast development of high-speed LTE and 5G networks in the country. Baseband unit (BBU), remote radio unit (RRU) and antenna (or active antenna unit (AAU) for 5G), optical fiber or parabolic antenna (microwave backhaul), power and battery, solar energy panels and savonius wind turbine, and any other accessories like a lifting platform, air conditioning and monitoring, are included into the mobile self-powered base station unit. The energy harvesting devices can cover the energy consumption of the base station system and can provide extra electricity for the resident of the modular house. The base station can include a water heat exchanger to warm water for use by the dwelling while providing cooling for the base station.

### BACKGROUND OF THE INVENTION

### 1. Field of the Invention

Embodiments of the invention relate generally to telecommunication devices. More particularly, embodiments of the invention relate to a self-powered base station for telecommunication devices that can be used in a modular house.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The increasing demand for stable and high-speed telecommunication poses great difficulties for the deployment of 4G LTE and 5G base stations across the country. Although nowadays, the reliability of optical fiber backhauls is stronger than wireless approaches, and the cost of optical fiber is not expensive, the deployment of optical fibers in vast land areas and even in cities requires a lot of manpower investment, adding extra cost for optical fiber deployment. In addition, deploying optical fiber needs to occupy land resource, while the private nature of land resources in United States makes the transaction cost of renting land for deployment remain high. Therefore, it is of great importance and urgency to use wireless methods (e.g., microwave backhaul, as an important part of wireless backhaul, is a low-cost and cost-effective approach) to work with optical fibers, and to develop new base station arrangement patterns for achieving better and cost-efficient signal quality and coverage.

Due to the short coverage distance of 5G signal, the number of 5G base stations must be about 3 times that of the 4G ones, if the same coverage of current 4G base stations is to be achieved. On the other hand, the maximum power consumption of a 5G base station is about 3-4 times that of a 4G one. So, in general, the total electricity cost of 5G base stations in the future will reach 9-10 times that of 4G.

The heating issue of a base station is critical for the long-term and efficient operation of the involved electronic devices. Traditionally, heat dissipation of a base station mainly relies on air cooling, such as air conditioning. Air-based cooling is minimally effective and will greatly increase power usage.

As can be seen, there is a need for a self-powered base station that can be incorporated into a modular house or other dwelling and that can adequately cool the base station to reduce issues of overheating.

### SUMMARY OF THE INVENTION

Embodiments of the present invention aim to solve the aforementioned problems in conventional telecommunication devices by providing a self-powered base station that can be incorporated as a functional unit within a modular house. The self-powered base station can be powered by at least one of a savonius wind turbine and a solar panel array. The self-powered base station can include a water heating system to providing cooling to the components of the base station while further providing warmed water to a dwelling, reducing the energy cost for heating water used in the dwelling.

Embodiments of the present invention provide a self-powered communication base station comprising base station equipment to provide communication between end users and communication towers, wherein the base station equipment includes at least one of an active antenna processing unit (AAU) and a remote radio unit (RRU); a self-contained power supply; and a battery to store power from the self-contained power supply, the battery providing power to operate the base station equipment.

Embodiments of the present invention provide a self-powered communication base station comprising base station equipment to provide communication between end users and communication towers, wherein the base station equipment includes at least one of an active antenna processing unit (AAU) and a remote radio unit (RRU); a self-contained power supply; a battery to store power from the self-contained power supply, the battery providing power to operate the base station equipment; and a water heating system, the water heating system comprising a plurality of cooling panels disposed adjacent at least a portion of the base station equipment, the water heating system including a pump for moving water from water source, through the plurality of cooling panels, and back to a warmed water storage tank.

Embodiments of the present invention provide a self-powered communication base station comprising base station equipment to provide communication between end users and communication towers, wherein the base station equipment includes at least one of an active antenna processing unit (AAU) and a remote radio unit (RRU); a savonius wind turbine rotatably disposed on a pole structure; a solar panel array; a battery to store power from the savonius wind turbine and the solar panel array, the battery providing power to operate the base station equipment; and a water heating system, the water heating system comprising a plurality of cooling panels disposed adjacent at least a portion of the base station equipment, the water heating system including a pump for moving water from water source, through the plurality of cooling panels, and back to a warmed water storage tank, wherein the warmed water storage tank supplies warmed water to a dwelling; and the self-powered communication base station is incorporated as a unit of the dwelling.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 illustrates a telecommunication architecture having dwellings with a self-powered base station according to exemplary embodiments of the present invention;

FIG. 2 illustrates a schematic representation of an energy harvesting system and a water heating system usable in a self-powered base station according to an exemplary embodiment of the present invention;

FIG. 3A illustrates a self-powered base station according to an exemplary embodiment of the present invention;

FIG. 3B illustrates the self-powered base station of FIG. 3A, with solar panels angled and a microwave antenna disposed thereon, further with a pole structure in a raised position;

FIG. 4A illustrates a detailed view of an antenna structure fixed at a terminal end of a pole structure, with a savonius wind turbine disposed to rotate about the pole structure, according to an exemplary embodiment of the present invention;

FIG. 4B illustrates a detailed view of a savonius wind turbine rotor used on the wind turbine of FIG. 4A; and

FIG. 4C illustrates a side view of a cooling panel usable in the self-powered base station according to an exemplary embodiment of the present invention.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a self-powered mobile base station unit, intended for modular houses and other dwellings, that is connected via optical fiber or microwave backhaul to provide for a better and more practical arrangement pattern of communication base station networks to cater for the fast development of high-speed LTE and 5G networks in the country. Baseband unit (BBU), remote radio unit (RRU) and antenna (or active antenna unit (AAU) for 5G), optical fiber or parabolic antenna (microwave backhaul), power and battery, solar energy panels and savonius wind turbine, and any other accessories like a lifting platform, air conditioning and monitoring, are included into the mobile self-powered base station unit. The energy harvesting devices can cover the energy consumption of the base station system and can provide extra electricity for the resident of the modular house.

Modular houses, providing a more convenient way for dwelling in the upcoming years, can be tailored with various functional units and assembled together. These functional units can include fitness units, office units and entertainment units, for example. Developing a mobile base station unit, which is compatible with modular houses and other dwellings, is of great value for telecommunication operators to easily establish a better telecommunication network around the country. Moreover, solar and wind energy harvesting devices can be integrated into the base station unit for powering the resident and covering the consumption of base station system.

As discussed above, air-based cooling is less effective and will greatly increase power usage compared to a liquid cooling method. Aspects of the present invention provide a liquid cooling plate fixed on the main heat-generating device (e.g., AAU, RRU, and BBU), and the heat is taken away by the liquid flowing through the cold plate to achieve the purpose of heat dissipation. The liquid in the cold plate does not touch the cooled device, and the heat conduction plate is used in the middle to transfer heat, which has high safety.

The figures are briefly described below, followed by a broader discussion of each figure and the components therein.

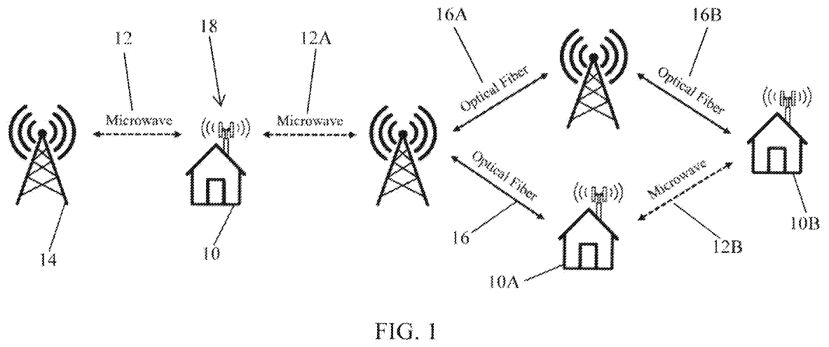

FIG. 1 shows a potential arrangement pattern for 4G LTE and 5G to achieve better signal coverage by adding self-powered mobile base station units for dwellings. Based on the easiness of deploying optical fiber in certain areas, operators can choose between an optical fiber approach or a microwave approach to connect the communication backhauls. With the increasing number of users who accept this residential base station unit, the dwellings will function as a small base station systems to network all surrounding devices for achieving much better signal quality and coverage in the region.

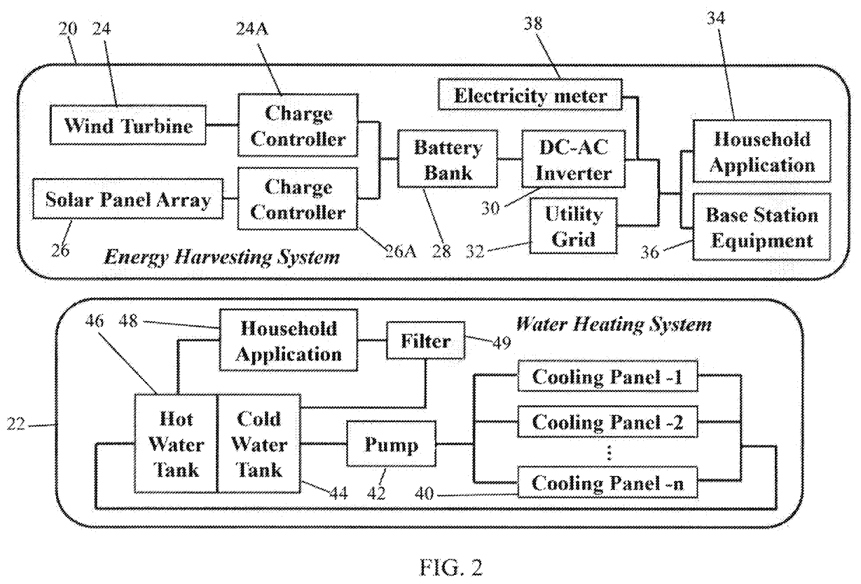

FIG. 2 describes the energy harvesting and water heating systems designed for the base station unit. Due to the heating problem and high-power consumption of a communicational base station, which would prevent residents from adding the mobile base station unit to their living places, these two embedded systems would relieve such concerns. To be specific, for the energy harvesting system, the charge controllers for both solar and wind energy harvesters will collect power and store it in a battery bank for further utilization for the operation of the base station and some household applications. Also, the utility grid can be used as a backup power resource for emergency power should the battery bank be overly depleted. On the other hand, the operation of equipment of the base station will generate a great amount of heat, and the water heating system based on liquid cooling units will take advantage of the heating resources and produce warm and hot water for the daily usage of residents by storing warmed water in a hot water tank which is connected with the household plumbing system.

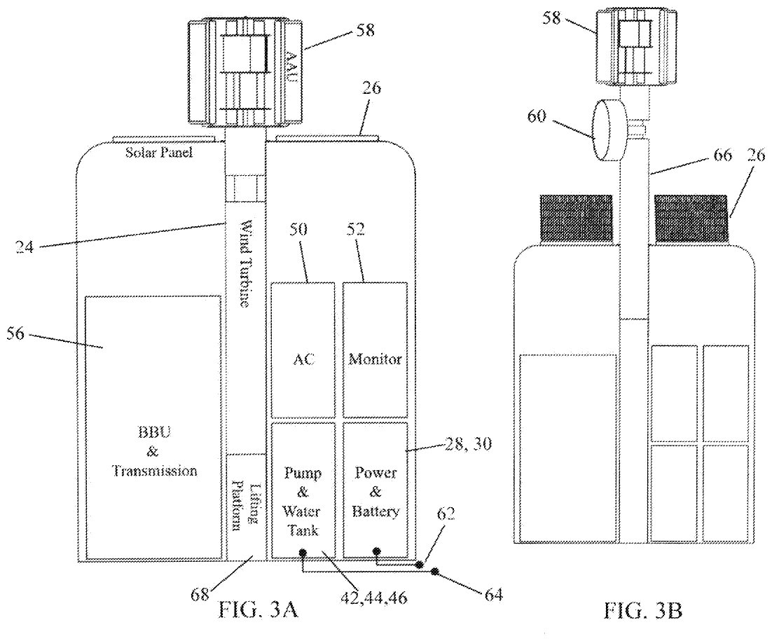

FIGS. 3A and 3B show the detailed structure of the pole terminal of the base station with a savonius wind turbine, three AAU or RRU and antenna devices, and an additional parabolic antenna to enable wireless transmission. AAU devices are evenly separated and connected to the framework, which is fixed onto the cylindrical structure without motion. When wind comes, the input shaft of savonius turbine will spin and such rotation will further be enhanced through the gear/belt system to obtain improved energy harvesting.

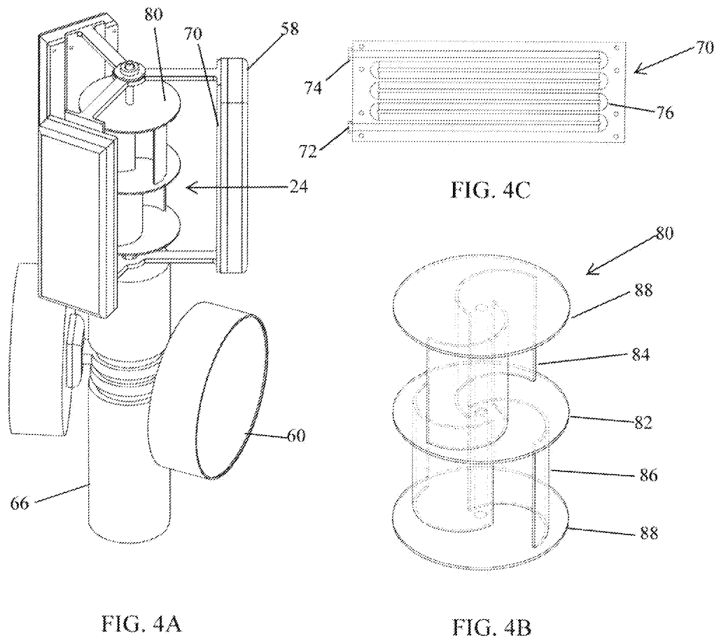

FIGS. 4A through 4C show the detailed structure of the pole terminal of the base station with integrated savonius wind turbine, three AAU or RRU and antenna devices, liquid cooling panels and an additional microwave antenna to enable wireless transmission. AAU devices are evenly separated and connected to the framework which is fixed onto the cylindrical pole without motion. The savonius wind rotor has many advantages over other vertical axis wind turbines in that the simpler and cheaper construction is provided. In addition, it is independent of the wind direction (no need to adjust the orientation of this base station unit) and has a good starting torque at a lower wind speed. To further improve the energy harvesting performance of the wind turbine, a configuration of double staged S-type rotor (two blades each stage) can be applied. This is because more wind will be deflected by a blade from entering the concave side of the adjacent blades with the increasement in blade number, and a two-stage setup will eliminate the dead zones left by the rotor's blades which are not rotating at that moment. So, when the pole is raised up and wind comes, the input shaft of savonius turbine will spin and such rotation will be further enhanced through the gear/belt system beneath to harvest wind energy. The details for the liquid cooling panel and turbine blade are illustrated in FIG. 4B.

Referring again to FIG. 1, a dwelling 10, or other similar structure, can support a self-powered base station 18 (also simply referred to as base station 18). The base station of the dwelling 10 can communicate via microwave backhaul 12, 12A with communication tower 14, 14A. In some embodiments, the communication tower 14A can communicate via optical fiber 16 with a base station of another dwelling 10A. The dwelling 10A may provide communication with a base station of even another dwelling 10B via a microwave backhaul 12B. Further, the dwelling 16B may communicate via optical fiber 16B with tower 14B. Of course, it should be understood that the communication scheme shown in FIG. 1 is exemplary and various other towers and self-powered base station deployment designs are envisioned within the scope of the present invention.

Referring to FIG. 2, a schematic representation of an energy harvesting system 20 and a water heating system 22 of the base station 18 (see FIG. 1) is shown. The energy harvesting 20 can be used to provide power to the base station equipment 36 and may be configured to provide excess power to household applications 34, to charge the battery bank 28 or even to provide power back to the utility grid 32. A DC-AC inverter may convert power from direct current (DC) (from the charge controllers 24A, 26A of the respective wind turbine 24 and solar panel array 26) to alternating current (AC) for use by the base station equipment, 36, the household applications 34 and/or the utility grid 32. An electricity meter 38 may be used to monitor the electricity flow, for example, to and from the utility grid 32. The battery bank 28 may receive power from the charge controllers 24A, 26A and provide DC power to the DC-AC inverter 30.

The base station equipment 36 can include one or more of the RRU or AAU, the lifting platform, the water pump, cooling equipment, monitors, microwave antennas, cooling panels, or the like, as described in greater detail below.

The water heating system 22 can include a plurality of cooling panels 40. The cooling panels 40, as illustrated by an exemplary cooling panel 70 in FIG. 4C, can include a water input 72 and a warmed water output 74, with a loop of pipe 76 formed therebetween. The plurality of cooling panels 40 can be disposed to contact the base station equipment 36, for example, to provide cooling thereto. In some embodiments, a cooling panel 40 may be disposed in an air intake (not shown) to cool air flowing over components, such as the base station equipment 36. In some embodiments, an exemplary cooling panel 70 can be disposed adjacent the AAU 58, as shown in FIG. 4A. The plurality of cooling panels 40 can receive cool water, via a pump 42, from, for example, a cool water tank 44, or from a municipal source or well, for example. The plurality of cooling panels 40 can deliver warmed water to a hot water tank 46, which may provide warmed water to household applications 48. The hot water tank 46 may be, for example, a conventional home water heater, where the warmed water from the plurality of cooling panels 40 can be further warmed, if necessary, therein. By providing warmed water to the hot water tank 46, the power needed to warm water can be significantly reduced. In some embodiments, a filter 49 may be used to filter water used in the water heating system 22.

Referring to FIGS. 2, 3A and 3B, the components of the self-powered base station unit 18 are shown. The RRU and antenna (not shown) or the AAU 58 for 5G communication, are installed onto a pole structure 66 equipped with the savonius wind turbine 24 in the middle position. This pole structure 66 can be connected to a vertical lifting platform 68 so as to adjust the height for better signal transmission. Optical fiber (not shown) can be used to connect RRU/AAU 58 with the BBU 56 located in the unit. When wireless transmission is needed, additional microwave antennas 60 can be installed onto the pole structure 66. The array of solar panels 26 can be attached on angling devices on top of the unit to harvest additional energy. The unit 18 can include air conditioning 50 as needed and monitoring systems 52, such as systems designed to monitor temperature, power use, signal strength, or the like. The pump and water tank 42, 44, 46 can be connected via connection 64 to the plumbing system of the dwelling. The power and battery devices, such as battery bank 28 and DC-AC converter 30 can have a connection 62 to the power system of the dwelling and/or to the utility grid 32.

As shown in FIGS. 4A and 4B, the AAU 58 can be attached, in a fixed orientation, on the pole structure 66, where the wind turbine 24 can be disposed inside the AAU 58 to rotate about the pole structure 66.

A savonius wind rotor 80 has many advantages over other vertical axis wind turbines including being a simple and inexpensive design. In addition, the savonius wind rotor 80 is independent of the wind direction, where there is no need to adjust the orientation of this base station unit, and has a good starting torque at a lower wind speed. To further improve the energy harvesting performance of the wind turbine 24, a configuration of double staged S-type rotor with two blades 84 in each stage is applied. As shown in FIGS. 4A and 4B, two stages, one with two blades 84, and the other with two blades 86, may be separated by a plate 82, with end plates 88 at the ends of the savonius wind rotor 80. The blades 84, 88 may be rotationally offset from each other, as shown. This design permits more wind to be deflected by a blade from entering the concave side of the adjacent blades with the increasement in blade number, and a two-stage setup will eliminate the dead zones left by the rotor's blades which are not rotating at that moment. So, when the pole is raised up and wind comes, the input shaft of savonius turbine will spin and such rotation will further be enhanced through the gear/belt system (not shown) beneath to harvest wind energy.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A self-powered communication base station comprising:
base station equipment to provide communication between end users and communication towers, wherein the base station equipment includes at least one of an active antenna processing unit (AAU) and a remote radio unit (RRU);
a self-contained power supply; and
a battery to store power from the self-contained power supply, the battery providing power to operate the base station equipment.

2. The self-powered communication base station of claim 1, wherein the self-powered communication base station is incorporated as a unit of a modular house or other dwelling.

3. The self-powered communication base station of claim 1, further comprising a water heating system, the water heating system comprising a plurality of cooling panels disposed adjacent at least a portion of the base station equipment, the water heating system including a pump for moving water from water source, through the plurality of cooling panels, and back to a warmed water storage tank.

4. The self-powered communication base station of claim 3, wherein the warmed water storage tank supplies warmed water to a dwelling.

5. The self-powered communication base station of claim 1, wherein the self-contained power supply includes a savonius wind turbine rotatably disposed on a pole structure.

6. The self-powered communication base station of claim 5, wherein a rotor of the savonius wind turbine includes at least a first set of vanes disposed about the pole structure and a second set of vanes disposed about the pole structure, the first set of vanes being rotationally offset from the second set of vanes.

7. The self-powered communication base station of claim 6, wherein the active AAU or the RRU are located at a rotationally fixed position at a distal end of the pole structure, the rotor of the savonius wind turbine rotor being positioned inside the AAU or the RRU.

8. The self-powered communication base station of claim 5, further comprising a lifting platform for raising and lowering the pole structure.

9. The self-powered communication base station of claim 1, further comprising a microwave antenna to provide backhaul communication with the communication tower.

10. The self-powered communication base station of claim 1, wherein the self-contained power supply includes a solar panel array.

11. The self-powered communication base station of claim 1, wherein the self-contained power supply includes a battery bank charged by at least one of a savonius wind turbine and a solar panel array.

12. A self-powered communication base station comprising:
base station equipment to provide communication between end users and communication towers, wherein the base station equipment includes at least one of an active antenna processing unit (AAU) and a remote radio unit (RRU);
a self-contained power supply;
a battery to store power from the self-contained power supply, the battery providing power to operate the base station equipment; and
a water heating system, the water heating system comprising a plurality of cooling panels disposed adjacent at least a portion of the base station equipment, the water heating system including a pump for moving water from water source, through the plurality of cooling panels, and back to a warmed water storage tank.

13. The self-powered communication base station of claim 12, wherein the self-contained power supply includes a savonius wind turbine rotatably disposed on a pole structure.

14. The self-powered communication base station of claim 13, wherein a rotor of the savonius wind turbine includes at least a first set of vanes disposed about the pole structure and a second set of vanes disposed about the pole structure, the first set of vanes being rotationally offset from the second set of vanes.

15. The self-powered communication base station of claim 14, wherein the active AAU or the RRU are located at a rotationally fixed position at a distal end of the pole structure, the rotor of the savonius wind turbine rotor being positioned inside the AAUR or the RRU.

16. The self-powered communication base station of claim 12, further comprising a lifting platform for raising and lowering the pole structure.

17. The self-powered communication base station of claim 12, wherein the self-contained power supply includes a solar panel array.

18. A self-powered communication base station comprising:
base station equipment to provide communication between end users and communication towers, wherein the base station equipment includes at least one of an active antenna processing unit (AAU) and a remote radio unit (RRU);
a savonius wind turbine rotatably disposed on a pole structure;
a solar panel array;
a battery to store power from the savonius wind turbine and the solar panel array, the battery providing power to operate the base station equipment; and
a water heating system, the water heating system comprising a plurality of cooling panels disposed adjacent at least a portion of the base station equipment, the water heating system including a pump for moving water from water source, through the plurality of cooling panels, and back to a warmed water storage tank, wherein
the warmed water storage tank supplies warmed water to a dwelling; and
the self-powered communication base station is incorporated as a unit of the dwelling.

19. The self-powered communication base station of claim 18, wherein a rotor of the savonius wind turbine includes at least a first set of vanes disposed about the pole structure and a second set of vanes disposed about the pole structure, the first set of vanes being rotationally offset from the second set of vanes.

20. The self-powered communication base station of claim 18, further comprising a lifting platform for raising and lowering the pole structure.
